(19) United States
(12) Patent Application Publication
(10) Pub. No.: US 2023/0232816 A1
(43) Pub. Date: Jul. 27, 2023

(54) DEVICE FOR DRAGGING AN ANIMAL CARCASS

(71) Applicant: Dennis Theriault, Sanford, ME (US)

(72) Inventor: Dennis Theriault, Sanford, ME (US)

(21) Appl. No.: 18/152,270

(22) Filed: Jan. 10, 2023

Related U.S. Application Data
(60) Provisional application No. 63/298,077, filed on Jan. 10, 2022.

(51) Int. Cl. A01M 31/00

(52) U.S. Cl. CPC A01M 31/006

(57) ABSTRACT

A device and method for dragging an animal carcass. The device connects to the head and front hooves of the carcass so that they are lifted off the ground when the device is used to drag the carcass. The device may include a dowel for being journaled through each front leg and the nose of the carcass. The device further includes a handle assembly that engages the protruding opposing ends of the journaled dowel so that the method of using the device does not require the user to tie any knots.

### CROSS-REFERENCE TO RELATED APPLICATION

This application claims the benefit of priority of U.S. Provisional Application No. 63/298,077, filed 10-JAN-2022, the contents of which are herein incorporated by reference.

### BACKGROUND OF THE INVENTION

The present invention relates to hunting accessories and, more particularly, a device for dragging an animal carcass.

When game hunting, once you shoot the game animal, “the work begins.” Obviously, the bigger the game animal the more work it takes the hunter to drag the carcass out from a remote area to the hunter’s vehicle or home. Deer, the most hunted big game animal, can weigh up to 300 pounds.

Unfortunately, currently is no solution that holds the head and front legs of the game animal off the ground when dragging the carcass without having to take the time and effort to tie and knot a rope.

As can be seen, there is a need for a device for dragging an animal carcass that lifts the head and front hooves of the carcass off the ground during dragging without having to tie any knots, thereby giving the hunter a better handle and smoother victory march with their trophy.

### SUMMARY OF THE INVENTION

The present invention embodies a dowel adapted to slide throw the carcass’s nose and feet, thereby the head of the carcass is prevented from getting tangled in trees, bushes, or other vegetation when being dragged through remote hunting grounds. A flexible handle connects to the engaged dowel to facilitate dragging of the carcass without having to tie a knot.

In one aspect of the present invention, a device for dragging an animal carcass, the device includes the following: an elongated member dimensioned to be simultaneously occupy incisions in two legs and a nose of the animal carcass so that opposing ends of the elongated member protrude from opposing sides of the animal carcass; and a handle assembly having the following: a handle portion; a tensile member; and two connectors, one disposed at opposing ends of the tensile member, wherein each connector operatively associates with a respective end of the elongated member.

In another aspect of the present invention, the device further includes wherein at least one end of the elongated member provides a tapered end, wherein the connectors are loops, and wherein each loop is formed by a retaining ring joining two portions of the tensile member and further including a central retaining ring joining two central portions of the tensile member so that the tensile member defines an X-shape during use.

In yet another aspect of the present invention, a method of dragging an animal carcass includes the following steps: sequentially journaling an elongated member through a first front leg, then a snout, and then a second front leg of the animal carcass; and directly connecting a tensile member to opposing ends of the elongated member that protrude from the animal carcass, whereby pulling on the tensile member elevates said snout and first and second front legs above a surface supporting a remainder of the animal carcass; operatively associating a handle portion to a midportion of the tensile member, wherein said midportion of the tensile member engages a hollow core of the handle portion, wherein the elongated member is a dowel with a tapered end, and wherein each end of the tensile member comprises a loop for directly engaging, respectively, the opposing ends of the dowel.

These and other features, aspects and advantages of the present invention will become better understood with reference to the following drawings, description and claims.

### BRIEF DESCRIPTION OF THE DRAWINGS

FIG. 1 is a plan or elevation view of an exemplary embodiment of the present invention, shown in use.

FIG. 2 is a plan or elevation view of an exemplary kit embodiment of the present invention.

FIG. 3 is a flow chart of an exemplary kit embodiment of the present invention, illustrating the kit construction 30.

FIG. 4 is a flow chart of an exemplary embodiment of the present invention, illustrating a method of use instructions 40.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a device and method for dragging an animal carcass that connects to and lifts the head and front hooves of the carcass off the ground, without the user having to tie any knots.

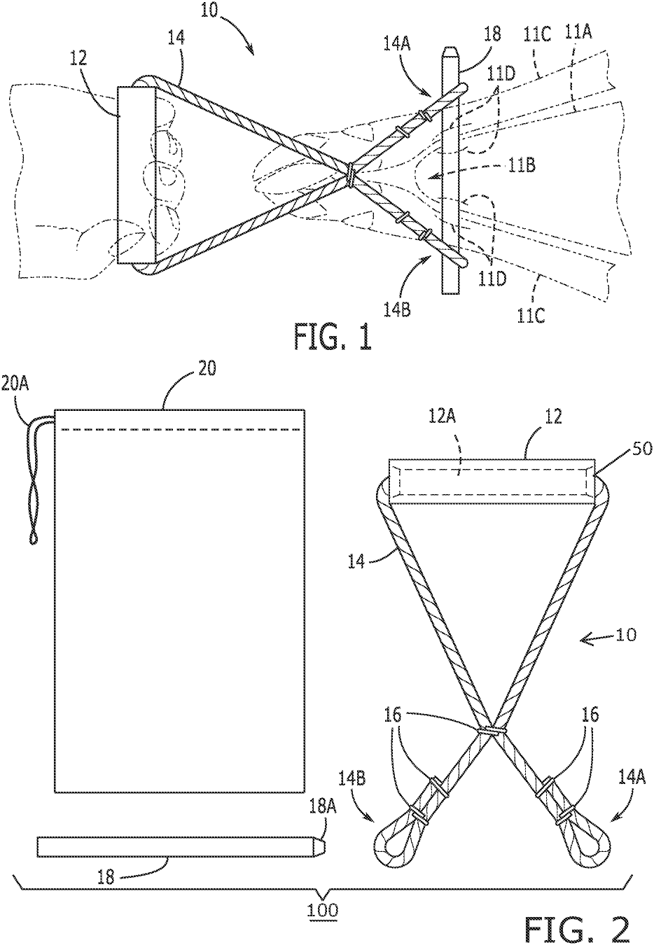

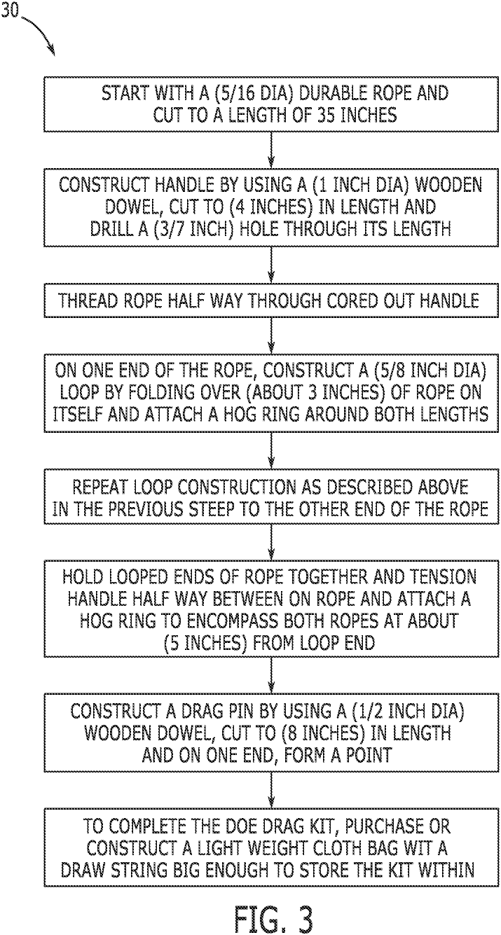

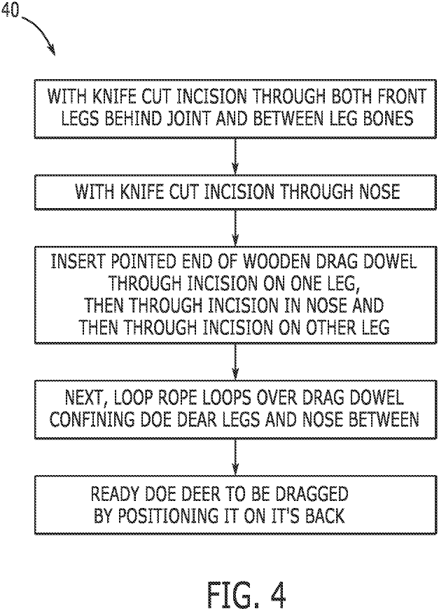

Referring now to FIGS. 1 through 4, the present invention may include a carcass-dragging device 10. The carcass-dragging device 10 may include a dowel 18 to engage the carcass and a handle assembly 50 that operatively associates with the dowel to facilitating dragging the carcass with the head and front legs thereof elevated off the ground.

The dowel 18 may be an elongated member having a tapered end 18A. The dowel 18 may be cylindrical, though other shapes may be suitable if they perform in accordance with the disclosure herein. Likewise, the dowel 18 may be made of various suitable materials such as wood, various plasticized materials, or the like.

The handle assembly 50 may include a handle portion 12 and an operatively associated tensile member 14. The opposing ends of the tensile member 14 connect the respective ends of the dowel 18 so that the operatively associated handle may be manipulated to drag the carcass engaged by the dowel 18. The handle portion 12 may be a tubular member with a hollow core 12A through which a portion of the elongated tensile member 14 occupies. The tensile member 14 may be any size and may be a rope or any other elongated, flexible, tension-strong filament or any suitable material capable of functioning as disclosed herein. The opposing ends of the tensile member 14 may form loops 14A and 14B. Though it is understood other forms of connectors may be used to operatively associate with the ends of the dowel 18. The tensile member 14 may provide retaining rings 16 (“hog rings”) to form each loop 14A and 14B as well as to join two portions of the tensile member 14 just inward of its ends to efficiently facilitate the transfer of tension force imparted by the handle portion 12 substantially equally to each tensile end connector/loop 14A and 14B.

The present invention also contemplates a carcass-dragging kit 100 that includes the carcass-dragging device 10 and a storage bag 20 (with a drawstring 20A or other closing element) to store them in.

A method of using the carcass-dragging device 10 includes the following steps. First, an incision 11D or through hole may be made through each front leg 11C of the carcass. Another incision 11D may be made through the nose 11B (“cold wet snout”) on the snout 11A of the carcass. Then the user may journal the dowel 18 (leading with the tapered end 18A) first through the incision 11D of a first leg 11C, then the incision 11D of the nose 11B, and then finally through the incision 11D of the second leg 11C so that both opposing ends of the dowel 18 protrude from opposing sides of the carcass, as illustrated in FIG. 1. Then the user would engage one protruding dowel end with the first loop 14A and the other protruding dowel end with the second loop 14B of the tensile member 14 so that the user can grab the handle portion 12 and drag the carcass along the ground to a desired location. The inventor has discovered that turning the carcass so that the underside of the snout 11A is facing substantially skyward facilitates the purpose of the invention, which is to handily keep the snout 11A and front portion of the front legs 11C lifted off the ground while dragging the carcass, thereby traversing the rugged landscape easier as the leading carcass body parts clear ground level obstacles, debris and vegetation.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A device for dragging an animal carcass, the device comprising:
an elongated member dimensioned to be simultaneously occupy incisions in two legs and a nose of the animal carcass so that opposing ends of the elongated member protrude from opposing sides of the animal carcass; and
a handle assembly comprising:
a handle portion;
a tensile member; and
two connectors, one disposed at opposing ends of the tensile member, wherein each connector operatively associates with a respective end of the elongated member.

2. The device of claim 1, wherein at least one end of the elongated member provides a tapered end.

3. The device of claim 2, wherein the connectors are loops.

4. The device of claim 3, wherein each loop is formed by a retaining ring joining two portions of the tensile member.

5. The device of claim 4, further comprising a central retaining ring joining two central portions of the tensile member so that the tensile member defines an X-shape during use.

6. A method of dragging an animal carcass, the method comprising:
sequentially journaling an elongated member through a first front leg, then a snout, and then a second front leg of the animal carcass; and
directly connecting a tensile member to opposing ends of the elongated member that protrude from the animal carcass,
whereby pulling on the tensile member elevates said snout and first and second front legs above a surface supporting a remainder of the animal carcass.

7. The method of claim 6, further comprising operatively associating a handle portion to a midportion of the tensile member.

8. The method of claim 7, wherein said midportion of the tensile member engages a hollow core of the handle portion.

9. The method of claim 8, wherein the elongated member is a dowel with a tapered end.

10. The method of claim 8, wherein each end of the tensile member comprises a loop for directly engaging, respectively, the opposing ends of the dowel.
